(19) United States
(12) Patent Application Publication
(10) Pub. No.: US 2009/0176520 A1
(43) Pub. Date: Jul. 9, 2009

(54) Generating User Contexts for Targeted Advertising

(75) Inventors: Shreyas B. S., Bangalore (IN); Narasimha Suresh, Bangalore (IN)

Correspondence Address: Rahman LLC, 10025 Governor Warfield Parkway, Suite 110, Columbia, MD, 21044, US

(73) Assignee: Telibrahma Convergent Communications Private Limited, Bangalore (IN)

(21) Appl. No.: 12/399,915

(22) Filed: Mar. 6, 2009

Related U.S. Application Data
(63) Continuation-in-part of application No. 11/734,302, filed on Apr. 12, 2007.

(51) Int. Cl. H04W 4/12; H04W 84/02; H04B 7/00; G06Q 30/00; G06Q 90/00

(52) U.S. Cl. 455/466; 370/338; 455/41.2; 705/14

(57) ABSTRACT

Embodiments herein disclose a method to facilitate user interaction to provide context sensitive content in a context generation system comprising of handheld devices with Bluetooth service activated, a plurality of Bluetooth terminals providing Bluetooth connectivity, a WLAN terminal and a central server, the method comprising a Bluetooth terminal delivering a web page through Bluetooth to a handheld device, where the web page coded in such a way that clicking on links in the page direct request to a local WLAN terminal; users clicking on the web page to request for content of their interest; the WLAN terminal decoding and redirecting request to a content source; the WLAN terminal receiving requested content page from the content source; the WLAN terminal encoding received content page such that links are directed to the WLAN terminal; and the WLAN terminal providing content page to the user.

### RELATED APPLICATIONS

This application is a continuation-in-part of and claims priority from subject matter disclosed in earlier filed patent application Ser. No. 11/734,302 filed on Apr. 12, 2007 by the applicant. Relevant portions of the aforementioned application are incorporated herein.

### FIELD OF INVENTION

The embodiments herein generally relate to mobile user context generation, and, more particularly, to context sensitive advertising using generated contexts for mobile users.

### BACKGROUND AND PRIOR ART

The common channels used for advertising are television, internet, and mobile among others. Various advertising methods are being used to make it more efficient.

With the rapid growth of telecommunications worldwide, mobile commerce has become a reality. Mobile communication has also become an important channel for marketing various services. Over past few years, email messages have been used to market services. Service providers obtain the email ids from various sources including other service providers in various domains who have access to information of their customers. Similarly, mobile devices being common today, various service providers having access to mobile contact information of their customers can potentially share such information with other marketing agencies or service providers who would want to market their services. However, privacy concerns attached to such sharing of mobile contact information is much more than it is to email id. At the same time, in order to market services, subscribers to such mobile contact information are also not guaranteed of their success through such sending campaigns to any available mobile contact information and they need to make sure that their advertisements are reaching the right audience by ensuring that the audience to which they are sending messages belong to a context related to the marketing effort.

Therefore, it is important to determine the advertisements that the user would be most receptive to ensuring that advertisements are not treated as spam and intruding in to users' privacy. This requires determination of context. Determining the exact context is complex as there are multiple dimensions to it. Context is a dynamically changing phenomenon and normally is quite ambiguous and subjective.

Attempts have been made to create a framework for delivering context sensitive advertisements. US patent application 20050080665A1 describes a context sensitive advertisement delivery framework where the specific advertisements are transmitted to the mobile wireless device. In this patent application an identifier associated with the mobile device and the state and location of the mobile device is ascertained after receiving a signal from the device. A context engine is used to update the profile database by using the gathered information. The location of the mobile is associated with a landmark in the profile database; the advertisements are then transmitted to the mobile device by selecting the advertisements from the advertisement database by utilizing the context engine based on identifier, state, location, and landmark of the mobile wireless. The patent application does not facilitate the user to choose the advertisement according to personal preferences.

However, contexts being dynamic, tracing a wireless mobile device using an identifier and the location of the device is not sufficient. Current system provides a new model for determining such contexts. System proposes having mechanisms to allow user to interact with the system at multiple network end points. These mechanisms provide various simplified ways for users to interact with a system through Bluetooth. These interactions along with location of the mobile phone, user profile and statistical modeling (based on the interaction patterns of other users) it would be possible to create set of contexts with detailed parameters. Based on the determined context a targeted communication can be determined that will be effective.

### SUMMARY OF INVENTION

One object of the present invention is to generate the context information of the user so as to facilitate context sensitive advertising on mobile devices.

Another object of the present invention is to encourage the user of the mobile device to participate in the system so as to generate user contexts based on interactions of users and location of users at multiple end points of a network.

Another object of the invention is to combine the different actions to create a context of the user based on the statistical analysis of interactions of other users.

Another object of the invention is to provide a method where context sensitive advertising is enabled without compromising on the privacy of users by providing users with a system specific application and informing the client that information will be transferred about user and his activities for presenting client with context sensitive advertisements and therefore making the advertising permission based.

Accordingly, the present invention provides a method and a system of generating plurality of user contexts by encouraging users to participate in the system through different end points and combining these actions at the plurality of end points to create a context for a user.

In one aspect, the present invention provides a method where user when engaging in multiple actions at different end points, the information of the actions being involved in is registered at a central server. Along with the information about actions, the location of the user is also tracked either through the end points that he/she is engaging with or by locating the user's mobile phone while he performs his actions. Also, various interactions of the user with the system through other means including interacting with a system through a handheld (through various applications specific to the system) for a multitude of purposes are tracked and information is collected. The actions are categorized in to pre-defined business event categories. Business events that the user is engaging in along with other parameters including user information and location information are mapped using a set of rules to determine one or more context. All such contexts with a given statistical confidence would be used as targets for sending targeted advertisements. Contexts could be mapped to an advertisement based on pre-defined rules.

In another aspect, the present invention provides a system. The system comprises of a handheld device for a user to interact with the system; a plurality of endpoints for users to interact; a centralized server for collecting information on all the events registered on any of the plurality of end points; a context filtering interface to determine the right context based on the events for which information is collected; and a rule engine to analyze the confidence level of each of such contexts to determine the usefulness of a context for sending advertisements.

In another aspect of the system, the user downloads a specific application onto this handheld device. The application downloaded enables a user to interact with the system through various sub-applications. This allows the system to collect information about user's activities on the handheld device specific to the application. The user is aware that the application transmits information about the user and his activities through the application downloaded to build his context and present context sensitive advertisements and thereby making the system permission based system that enables targeted advertising to mobile users.

In a preferred embodiment of the present invention, the aforementioned system is a combination of hardware and software.

Disclosed herein is a computer program product, embodied in a computer readable medium comprising program code to execute a method of generating user contexts, to enable context sensitive advertising, by encouraging users of a system to participate through different end points of the system and using information of user actions, profile and location to generate context, the method comprising the steps of: storing information about users and their profiles at a central server, where the initial user profile is generated upon user registration; registering information of the actions, in which users engage at different end points of the system, and the location of the actions at a central server; categorizing actions in to pre-defined business events; and generating contexts of users by combining their profile information with the information on business events; choosing appropriate contexts by filtering the generated contexts based on statistical analysis of previous history of such actions by users. The location of the user is also tracked through the end points users engage with or by locating the mobile phone of users while users perform their actions. The step of generating and filtering a context includes an algorithm for building weighted average table to determine optimal promotion comprising the steps of: collecting business event information; identifying user behavior for a set of same endpoint interactions; identifying user behavior with similar endpoints; identifying summary of interactions of other users with similar profiles for a particular endpoint; and preparing a weighted average of responses of users in different scenarios in a table to identify effectiveness of promotions for a given set of profiles, location, and business events. The user profile and the user context are updated by tracking user actions to accommodate the most recent behavior in to the context.

Embodiments herein disclose a method to facilitate user interaction to provide context sensitive content in a context generation system comprising at least a plurality of handheld devices with Bluetooth service activated, a plurality of Bluetooth terminals providing Bluetooth connectivity, a WLAN terminal and a central server, the method comprising: a Bluetooth terminal delivering a web page through Bluetooth to a handheld device, where the handheld device is in the area of coverage of the Bluetooth terminal and where the web page coded in such a way that clicking on links in the page direct request to a local WLAN terminal; users clicking on the web page to request for content of their interest; the WLAN terminal decoding and redirecting request to a content source; the WLAN terminal receiving requested content page from the content source; the WLAN terminal adding context sensitive information to the received content page; the WLAN terminal encoding received content page such that links are directed to the WLAN terminal; and the WLAN terminal providing content page to the user. The content source is a valid URL on the Internet or a local content server. The context sensitive information is a context sensitive advertisement embedded in the content page sent to a handheld device, where context is built based on at least user requests, user interactions, user location, and user profile information.

Also, disclosed is a method to facilitate user interaction to provide context sensitive content in a context generation system comprising at least a plurality of handheld devices with Bluetooth service activated, a plurality of Bluetooth terminals providing Bluetooth connectivity, a WLAN terminal and a central server, the method comprising: a Bluetooth terminal and said central server performing OTA provisioning of wireless access point on a handheld device; the Bluetooth terminal delivering a web page through Bluetooth to the handheld device, where the handheld device is in the area of coverage of the Bluetooth terminal and where the web page is coded in such a way that clicking on links in the page directs the request to a local WLAN terminal; user clicking on the web page to request for content of their interest through the WLAN terminal decoding the request and redirecting request to a content source; the WLAN terminal receiving requested content page from the content source; the WLAN terminal adding context sensitive information to the received content page; the WLAN terminal encoding received content page such that links are directed to the WLAN terminal; and the WLAN terminal providing content page to the user. The content source is a valid URL on the Internet or a local content server. The context sensitive information is a context sensitive advertisement embedded in the content page sent to a handheld device, where context is built based on at least user requests, user interactions, user location, and user profile information.

Embodiments also disclose a system, the system facilitating user interaction to provide context sensitive content in a context generation system comprising at least a plurality of handheld devices with Bluetooth service activated, a plurality of Bluetooth terminals providing Bluetooth connectivity, a WLAN terminal and a central server, the system performing steps of a Bluetooth terminal and the central server performing Over-The-Air (OTA) provisioning of wireless access point on a handheld device; the Bluetooth terminal delivering a web page through Bluetooth to the handheld device, where the handheld device is in the area of coverage of the Bluetooth terminal and where the web page coded in such a way that clicking on links in the page direct request to a local WLAN terminal; users clicking on the web page to request for content of their interest; the WLAN terminal decoding and redirecting request to a content source; the WLAN terminal receiving requested content page from the content source; the WLAN terminal adding context sensitive information to the received content page; the WLAN terminal encoding received content page such that links are directed to the WLAN terminal; and the WLAN terminal providing content page to the user. The OTA provisioning of wireless access point on a handheld device further comprises of the system performing steps of a Bluetooth terminal sending a web page with form to a handheld device; user filling web page form with at least mobile number of the handheld device; web page form request being sent to the central server as an SMS; the central server recognizing the request and delivering a WAP push message comprising wireless access point information; and wireless access point being provisioned on the handheld device.

Embodiments herein also disclose a system, the system facilitating user interaction to provide context sensitive content in a context generation system comprising at least a plurality of handheld devices with Bluetooth service activated, a plurality of Bluetooth terminals providing Bluetooth connectivity, a WLAN terminal and a central server, the system performing steps of a Bluetooth terminal and the central server performing Over-The-Air (OTA) provisioning of wireless access point on a handheld device; the Bluetooth terminal delivering a web page through Bluetooth to the handheld device, where the handheld device is in the area of coverage of the Bluetooth terminal and where the web page coded in such a way that clicking on links in the page direct request to a local WLAN terminal; user clicking on the web page to request for content of their interest; the WLAN terminal decoding and redirecting request to a content source; the WLAN terminal receiving requested content page from the content source; the WLAN terminal adding context sensitive information to the received content page; and the WLAN terminal providing content page to the user. The OTA provisioning of wireless access point on a handheld device further comprises of the system performing steps of a Bluetooth terminal sending a web page with form to a handheld device; user filling web page form with at least mobile number of the handheld device; web page form request being sent to the central server as an SMS; the central server recognizing the request and delivering a WAP push message comprising wireless access point information; and wireless access point being provisioned on the handheld device.

Embodiments also disclose a method of simplifying user interactions through Bluetooth, the method comprising steps of providing at least one central server, for providing Bluetooth connectivity to plurality of handheld devices; providing at least one Bluetooth terminal, for interfacing between the central server and the plurality of handheld devices; providing at least one WLAN terminal, for providing content to users of the plurality of handheld devices; where the Bluetooth terminal and the central server performing Over-The-Air (OTA) provisioning of wireless access point on a handheld device; the Bluetooth terminal delivering a web page through Bluetooth to the handheld device, where the handheld device is in the area of coverage of the Bluetooth terminal and where the web page coded in such a way that clicking on links in the page direct request to the WLAN terminal; users clicking on the web page to request for content of their interest; the WLAN terminal decoding and redirecting request to a content source, where the content source is a valid URL on the internet or a local content server; the WLAN terminal receiving requested content page from the content source; the WLAN terminal adding context sensitive information to the received content page, where the context sensitive information is a context sensitive advertisement embedded in the content page sent to a handheld device and the context is built based on at least user requests, user interactions, user location, and user profile information; the WLAN terminal encoding received content page such that links are directed to the WLAN terminal; and the WLAN terminal providing content page to the user. The OTA provisioning of wireless access point on a handheld device further comprises of a Bluetooth terminal sending a web page with form to a handheld device; user filling web page form with at least mobile number of the handheld device; web page form request being sent to the central server as an SMS; the central server recognizing the request and delivering a WAP push message comprising wireless access point information; and wireless access point being provisioned on the handheld device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The embodiments herein will be better understood from the following description with reference to the drawings, in which:

FIG. 1 shows a flowchart depicting the method of the invention, according to embodiments as disclosed herein;

FIG. 2 shows the logical view of the system with the various components within the system, according to embodiments as disclosed herein;

FIG. 3 shows how the system updates itself to build a context based on various activities, according to embodiments as disclosed herein;

FIG. 4 is a network block diagram, according to embodiments as disclosed herein;

FIG. 5 depicts a WLAN terminal, according to embodiments disclosed herein; and

FIGS. 6A and 6B depict a method in a flowchart, according to embodiments as disclosed herein.

### DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

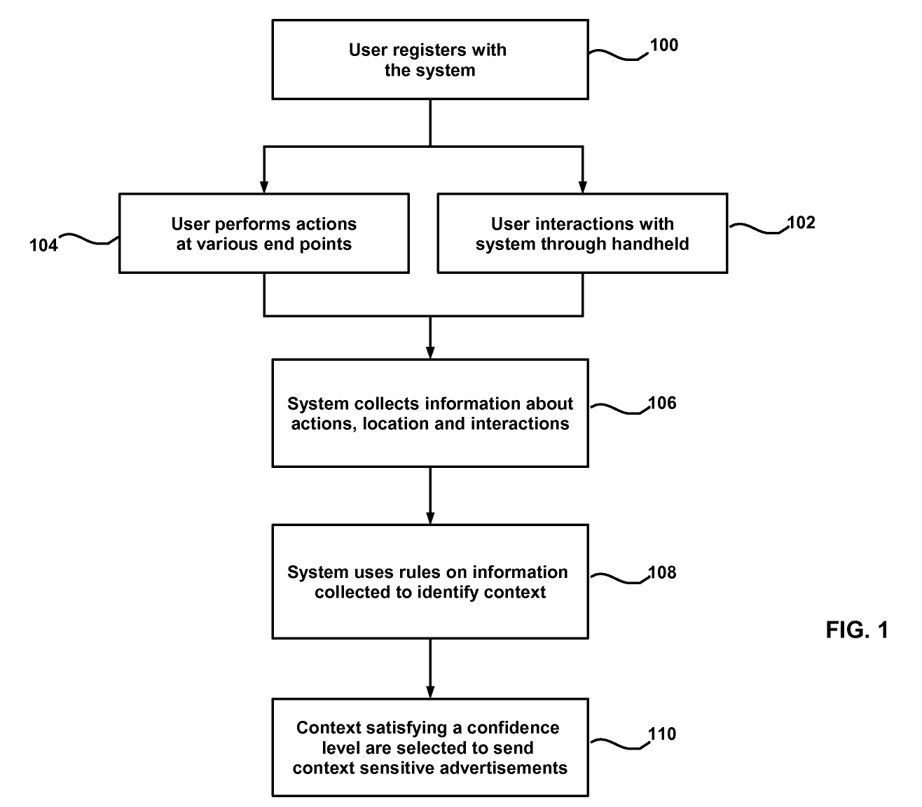

Embodiments herein provide for generating user contexts by having mechanisms to allow user to interact with the system at multiple network end points. These interactions along with location of the mobile phone, users' profiles and statistical modeling (based on the interaction patterns of other users), and delivering context sensitive targeted advertisements. Referring now to the drawings, and more particularly to FIGS. 1 through 6, where similar reference characters denote corresponding features consistently throughout the figures, there are shown preferred embodiments.

FIG. 1 shows the method of the invention. According to the method of the invention users register with a system (100). A user when engaging in multiple actions at different end points (104), the information of the actions that the user is involved in is registered at a central server (106). Along with the information about actions, the location of the user is also tracked either through the end points that engaging with or by locating the user's mobile phone while he performs his actions. Also, various interactions of the user with the system through other means including interacting with a system through a handheld (through various applications specific to the system downloaded on to the handheld) for a multitude of purposes are tracked and information is collected (102). The actions are categorized in to pre-defined business event categories. Actions along with other parameters including user information and location information are mapped using a set of rules to determine one or more context. The rules are derived through statistical analysis of various actions of other users and the advertisements that such users used. All such contexts with a pre-defined minimum statistical confidence (or correlation) would be used as targets for sending promotions (110). Contexts could be mapped to a promotion/message based on pre-defined rules.

In various embodiments, users engage with multiple end points through different mechanisms including but not limited to P2P messaging, downloading information (data, audio, visual) on to mobile device, performing certain actions (like buying a ticket). Examples of interaction include users using the client downloaded to his handheld for searching information, buying ticket, downloading coupon etc; users sending message to query for a particular information; users using the client downloaded to engage in communications with his peers (Chat, blog); users using the downloaded ticket in a point of entry; and users using the downloaded coupon near a POS.

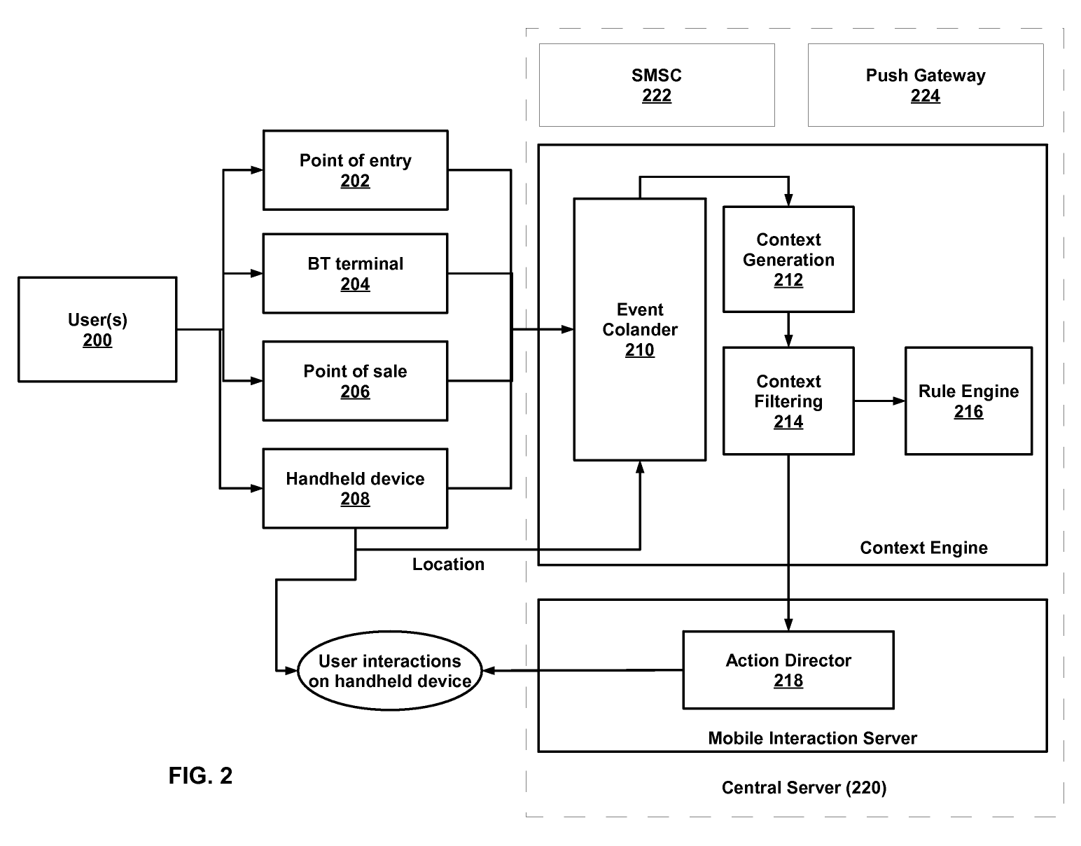

FIG. 2 shows the logical view of the system with the various components within the system. The system comprises of a handheld device (208) for a user to interact with the system; a plurality of endpoints for users to interact (202, 204, 206); and a centralized server (220) for collecting information on all the events registered on any of the plurality of end points comprising a context engine and a mobile interaction server. The server (220) includes at least of a context, a mobile interaction server, and a SMS center (SMSC, 222).

The context engine comprises of an event colander (210); a context generation module (212); a context filtering interface (214) to determine the right context based on the events for which information is collected; and a rule engine (216) to analyze the confidence level of each of such contexts to determine the usefulness of the context for sending promotions based on correlation analysis of interactions of users and usefulness of advertisements pushed to their mobile devices using the system specific application. The context generation module collects event information from the event colander and forwards the context related information including the event information, user profile, user location information etc. to the context filtering interface. The context filtering interface utilizes the rule engine to map user activities into set of event and the set of events to a context. The rule engine uses the information forwarded to perform correlation analysis between similar actions/events (ex: action could be enquiring for availability of movie tickets and an event could watching a movie) and the kind of advertisements that they have accessed/viewed. Based on the information collected and the correlation history, the rule engine suggests appropriate contexts. The mobile interaction server of the centralized server comprises of an action director (218) to direct behavior of the application on the handheld device according to the interactions of the user. Based on the contexts built, action director (218) could be used to forward relevant advertisements or messages that could be useful to the users. The action director itself might contain another rule engine to map contexts to advertisements based on a bidding mechanism or any other such mechanism. The SMSC (222) is used for receiving and sending SMS messages. The SMS messages may be system specific messages or general SMS messages. In another embodiment, the SMSC (222) may be situated outside of the central server (220).

In various embodiments, a collection of endpoints (where the user interactions are targeted at) may include

1. Those situated in various geographical locations with which user can interact (Blue Tooth Terminals)

2. Those are connected over internet for user to interact over GPRS/SMS and similar networks

3. Point of sales, point of entry and similar terminals where user can interact for the purpose of payment, collection, redeeming coupons etc.

Actions or interactions that a user is involved in at the end points could include and is not limited to the following:

1. User using a promotional key at a point of sale terminal

2. User paying for certain type of goods at a point of sale terminal

3. User withdrawing money from ATM and filling petrol

4. User withdrawing money from ATM and parking his car at a identified place

5. User withdrawing money from ATM and using his mobile ticket at an identified point of entrée

6. User interacting with various applications on his handheld device like:

1. searching for a given services in a particular area

2. using the application in a given area

3. downloading a given type of content

4. engaging in chatting with old friends

5. engaging in public room chat

6. searching for people to chat

Using the information collected about the user, his profile and his activities, the context engine builds a context that could be used to send advertisements of companies that would be interested in advertising to users belong to such contexts. The contexts built are stored on the centralized server either in a database or any other physical memory on the server.

An example of the data structure of a context built and stored is as follows:

| | User Id/Mobile number |
|---|---|
| User Identification | |
| Mobile type | Endpoint interaction id |
| | Transaction parameters |
| | Time of event |
| User Profile | User Id/Mobile number |
| | Age group |
| | Spending type |
| | Income group |
| | User since |
| | Last accessed |
| | Interaction domains (Sports/ |
| | music/movie) |
| | Opt-in for advertisements |
| User History | User Id |
| | Endpoint Id |
| | Promotion Id |
| | Level of interaction from the user |
| Location Information | |
| | Location Id |
| Endpoint Interactions | Endpoint Interaction Id |
| | Endpoint Id |
| | Location Id |
| | Transaction type |

Examples of context that the context engine can identify could include and is not limited to the following:

1. User is available near a Bluetooth terminal and the user downloaded a specific content

2. User is available near a Bluetooth terminal and the user interacted with the terminal

3. User is involved in a terminal specific event (ex: asking for specific information like information about movies at a cinema; doing specific transactions like buying tickets for a movie at a cinema)

The process for building and filtering a context includes an algorithm for building weighed average table to determine optimal promotion. Broadly, the algorithm involves the following steps:

4. Collecting the event

5. Identifying user behavior for a set of same endpoint interactions

6. Identifying user behavior with similar endpoints

7. Identifying summary of interactions with other similar users related to a particular endpoint

8. Preparing a weighted average of relevant responses in a table

Upon collecting information on events and user behaviors for different scenarios, value estimation is done for each user based on value generated by the user through previous promotions. A table is generated with data of value generated by users in different scenarios and the table is used to determine optimal promotion when a promotion needs to be sent.

The system of the invention allows a user to download a specific application onto his handheld device. The application downloaded enables a user to interact with the system through various sub-applications. This allows the system to collect information about user's activities on the handheld device specific to the application and the user is aware that the application transmits information about the user and his activities to build his context and present context sensitive advertisements on his device through the application downloaded and therefore making the advertising permission based.

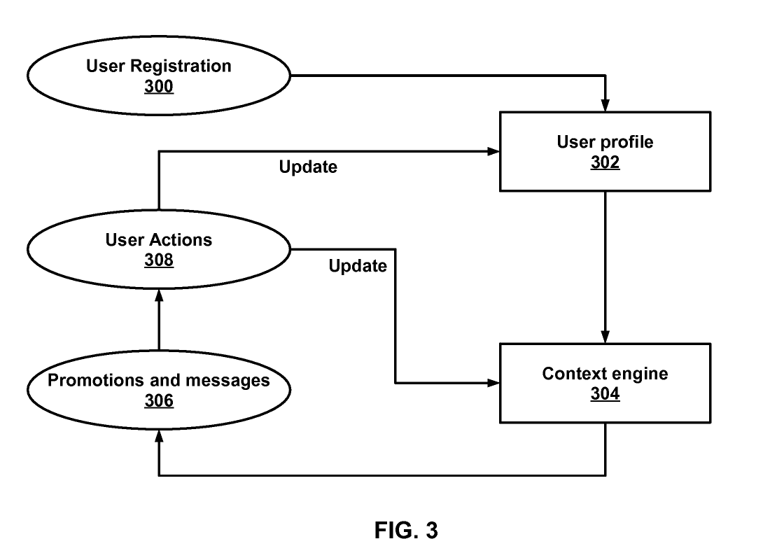

FIG. 3 shows how the system updates itself to build a context based on various activities. An initial user profile is generated upon user registration (300). And based on the user profile (302) and user actions (308) (at the end points and at the application on handheld), the context engine (304) builds a context. The context built by the context engine (304) is used to send context sensitive advertisements (306). Based on further user actions, the user profile and the user context are updated to accommodate the most recent behavior in to the context.

In a preferred embodiment of the present invention, the aforementioned system is a combination of hardware and software.

Integrating Bluetooth and WLAN for User Interaction

Embodiments herein further achieve integration between a Bluetooth network and Wireless Local Area Network (WLAN) to enable user interaction and therefore identifying user context for delivering context sensitive advertisements.

A handheld device is connected to a Bluetooth network, where the handheld device has the Bluetooth service activated. The Bluetooth network comprises of a plurality of Bluetooth terminals connected to a central server. In a preferred embodiment, Over-The-Air (OTA) provisioning of wireless access point is performed on handheld devices before users can actually request content. The Bluetooth terminal sends a web page to the handheld device with a form to be filled using Bluetooth. The web page may be a WAP page. The user of the handheld device fills in details including at least the mobile number of the handheld device. The form submission request from the web page is sent as an SMS to the server. The SMS may contain a predefined short code along with the other information provided by the user. The server recognizes the SMS message as a request to provide wireless access point information and delivers a WAP push message comprising the wireless access point information. After user completes the wireless registration, the Bluetooth terminals push a web page the handheld device, where the web page is specially coded such that if the user clicks a link in the web page, a request is sent by the device to a WLAN terminal. The WLAN terminal fetches the requested information and sends the information to the handheld device. Having the WLAN terminal in between the handheld devices and the internet provides an opportunity to include context sensitive content including advertisements as part of content delivered to users.

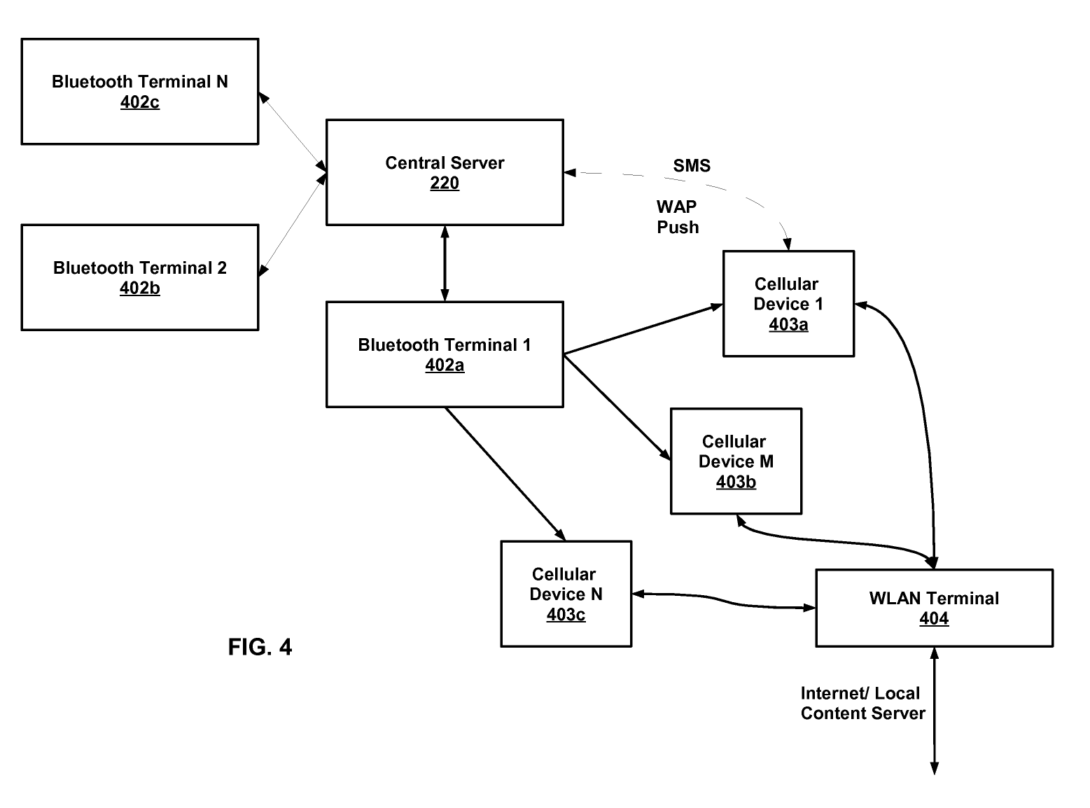

FIG. 4 is a network block diagram, according to embodiments as disclosed herein. The diagram depicts a central server 220, a plurality of Bluetooth terminals 402, a plurality of handheld devices 403 and a WLAN terminal 404. A handheld device present in the coverage area of a Bluetooth terminal and having Bluetooth service activated may connect to the Bluetooth network through one of the Bluetooth terminals 402. Considering the scenario where handheld device 403a is connected to the Bluetooth terminal 402a, the Bluetooth terminal sends a web page to the handheld device 403a with a form to be filled using Bluetooth. The web page may be a WAP page. The user of the handheld device 403a fills in details including at least the mobile number of the handheld device. The form submission request from the web page is sent as an SMS to the server 220. The SMS may contain a predefined short code along with the other information provided by the user. The server comprises of a Mobile originated (MO) and Mobile Terminated (MT) interface to a SMS gateway. The server uses the MO interface to receive SMS from end users mobile device and deliver relevant information to the user mobile through the MT interface. The server 220 recognizes the SMS message as a request to provide wireless access point information and delivers a WAP push message comprising the wireless access point information. User may register his device to the wireless access point. Once the registration is done, the Bluetooth terminal 402a pushes a specially encoded web page to the handheld device 403a. The WAP page is coded in such a way that clicking a link on the page will result in a request being sent to the WLAN terminal 404 using WLAN connection. The WLAN terminal 404 responds to the request from the user by retrieving the requested information and sending the information to the user using the WLAN connection. A user using his handheld device 403 may request for information, which may be found in a local server or on the Internet. Consequently, the WLAN terminal 404 may retrieve the content either from a local server or from the Internet. The central server 220 may act as a local content server and serve content for user requests. In a preferred embodiment, local server comprises of location specific information. For example, a user may request for a page which contains all the sales and special offers currently available in the vicinity of the area the user is present.

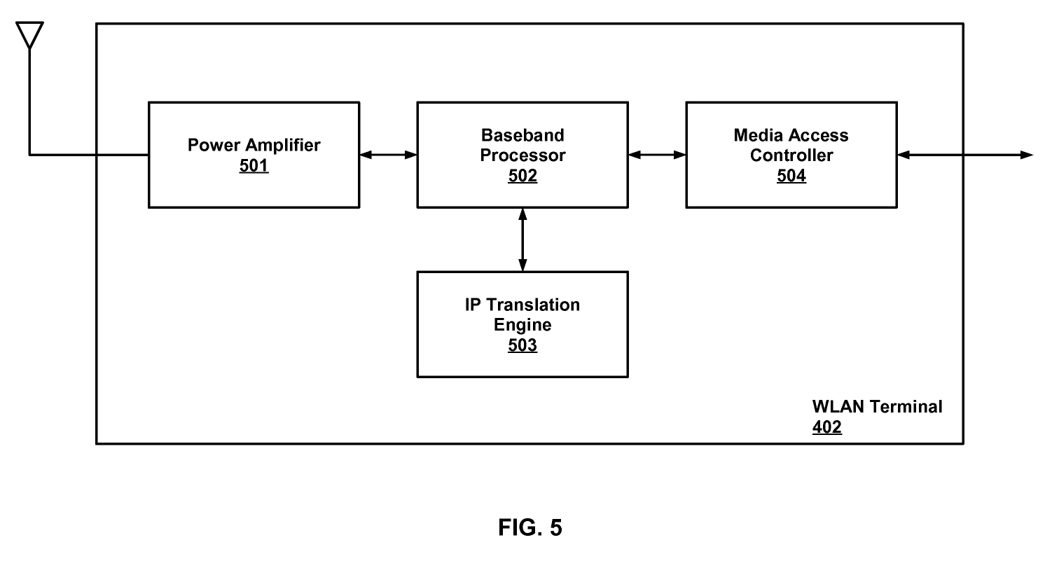

FIG. 5 depicts a WLAN terminal, according to embodiments disclosed herein. The WLAN terminal 404 comprises of a power amplifier 501, a baseband processor 502, a translation engine 503 and a media access controller 504. The baseband processor 502 is a processor designed for processing information and data related to wireless communication. The baseband processor 502 implements the modulation and demodulation schemes required for the PHY layer and runs at the frequency of the wireless technology. For example, in the WLAN terminal, the baseband processor 502 runs at 2.4 GHz if 802.11b/g is used. The media access controller 504 supports the communications protocol. The translation engine 503 translates the internal addresses received by the WLAN terminal 404 from the user of the handheld device 403 into external addresses. Similarly, the translation engine 503 also translates the external links in the content requested by the user of the handheld device 403 into internal links, before the WLAN terminal sends the content to the handheld device 403.

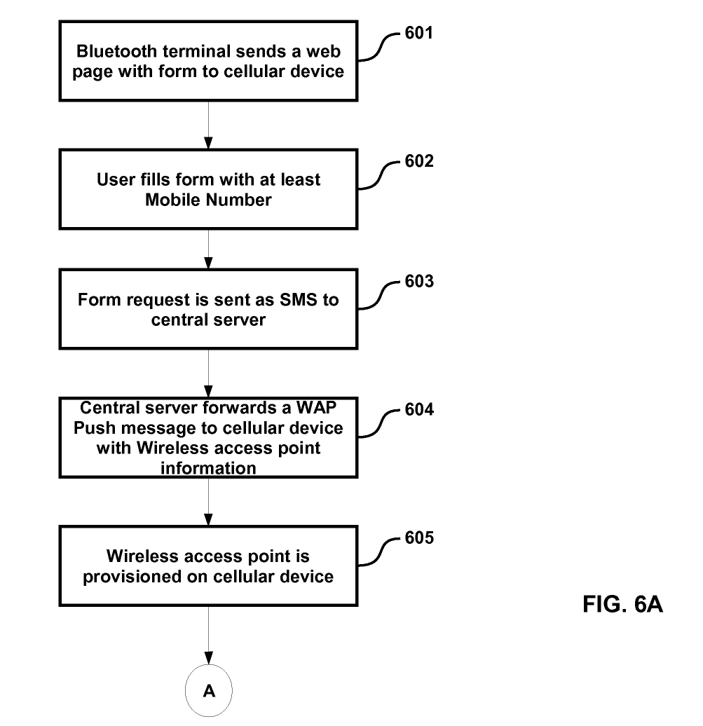

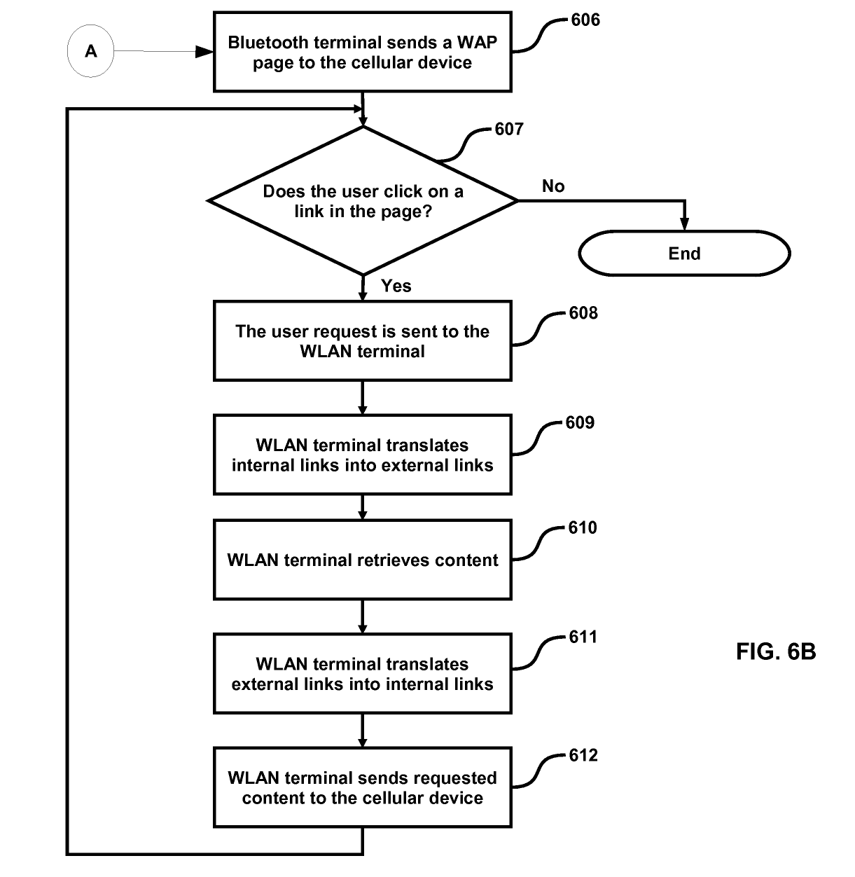

FIGS. 6A and 6B depict a method in a flowchart, according to embodiments as disclosed herein. There are a plurality of Bluetooth terminals 402 connected to a central server 220, which offer Bluetooth coverage over a specified area. A handheld device present in the coverage area and having Bluetooth service activated may connect to the Bluetooth network through one of the Bluetooth terminals 402. The Bluetooth terminal sends (601) a web page to the handheld device with a form to be filled using Bluetooth. The user of the handheld device fills in details (602) including at least the mobile number of the handheld device. The form submission request from the web page is sent (603) as an SMS to the server. The server recognizes the SMS message as a request to provide wireless access point information and delivers (604) a WAP push message comprising the wireless access point information. User completes (605) the wireless access point registration using the information provided through the WAP push message.

Once the wireless access point provisioning is complete, the Bluetooth terminal 402 pushes (606) a specially encoded web page to the handheld device 403. The web page has been specially coded in such a way that clicking on a link present in the page results in a request being sent to the WLAN terminal 404. If the user clicks on a link (607) in the web page, the user request is sent (608) through the WLAN connection to the WLAN terminal 404. The WLAN terminal translates (609) the internal links in the request received from the user into external links. The WLAN terminal then retrieves (610) the content requested by the user. The user using his handheld device 403 may request for information, which may be found in a local server or on the Internet. The WLAN terminal 404 may retrieve the content from an internal server or from the Internet. The local server may comprise of location specific information. For example, a user may request for a page which contains all the sales promotions and special offers currently available in the vicinity of the area the user is present. The WLAN terminal translates (611) the external links in the retrieved content into internal links and sends the requested content to the handheld device 403. The various actions in method as depicted in FIGS. 6A and 6B may be performed in the order presented, in a different order or simultaneously. Further, in some embodiments, some actions listed in FIGS. 6A and 6B may be omitted.

When a user wants to access content present on the internet, the user clicks on a link in a web page presented to him. The link points at an external URL (Uniform Resource Locator), but is coded in the form of an internal link which directs the request from the user to the WLAN terminal. The WLAN terminal on receiving the link from the user decodes the internal link and extracts the external link, which is used by the WLAN terminal to fetch content from the internet. In a similar manner, in the content fetched from the internet, all the links, which currently point to external links, are encoded by the WLAN terminal into internal links.

In some embodiments, only the first page is coded with links pointing to the local WLAN terminal. Subsequent pages requested may be sent without any coding in the WLAN terminal.

The embodiments herein can take the form of an entirely hardware embodiment, or an embodiment including both hardware and software elements. The software elements may include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the disclosed invention.

What is claimed is:

1. A method to facilitate user interaction to provide context sensitive content in a context generation system comprising at least a plurality of handheld devices with Bluetooth service activated, a plurality of Bluetooth terminals providing Bluetooth connectivity, a WLAN terminal and a central server, the method comprising:
a Bluetooth terminal and said central server performing Over-The-Air (OTA) provisioning of wireless access point on a handheld device;
said Bluetooth terminal delivering a web page through Bluetooth to said handheld device, where said handheld device is in the area of coverage of said Bluetooth terminal and where said web page coded in such a way that clicking on links in said page direct request to a WLAN terminal;
users clicking on said web page to request for content of their interest;
said WLAN terminal decoding and redirecting request to a content source;
said WLAN terminal receiving requested content page from said content source;
said WLAN terminal adding context sensitive information to said received content page;
said WLAN terminal encoding received content page such that links are directed to said WLAN terminal; and
said WLAN terminal providing content page to said user.

2. The method as in claim 1, where said content source is a valid URL on the Internet.

3. The method as in claim 1, where said content source is a local content server.

4. The method as in claim 1, where said context sensitive information is a context sensitive advertisement embedded in said content page sent to a handheld device;

5. The method as in claim 1, where context is built based on at least user requests, user interactions, user location, and user profile information.

6. The method as in claim 1, where OTA provisioning of wireless access point on a handheld device further comprises of:
a Bluetooth terminal sending a web page with form to a handheld device;
user filling web page form with at least mobile number of the handheld device;
web page form request being sent to said central server as an SMS;
said central server recognizing the request and delivering a WAP push message comprising wireless access point information; and wireless access point being provisioned on said handheld device.

7. A system, said system facilitating user interaction to provide context sensitive content in a context generation system comprising at least a plurality of handheld devices with Bluetooth service activated, a plurality of Bluetooth terminals providing Bluetooth connectivity, a WLAN terminal and a central server, the system performing steps of:
a Bluetooth terminal and said central server performing Over-The-Air (OTA) provisioning of wireless access point on a handheld device;
said Bluetooth terminal delivering a web page through Bluetooth to said handheld device, where said handheld device is in the area of coverage of said Bluetooth terminal and where said web page coded in such a way that clicking on links in said page direct request to a local WLAN terminal;
users clicking on said web page to request for content of their interest;
said WLAN terminal decoding and redirecting request to a content source;
said WLAN terminal receiving requested content page from said content source;
said WLAN terminal adding context sensitive information to said received content page;
said WLAN terminal encoding received content page such that links are directed to said WLAN terminal; and
said WLAN terminal providing content page to said user.

8. The system as in claim 7, where OTA provisioning of wireless access point on a handheld device further comprises of said system performing steps of:
a Bluetooth terminal sending a web page with form to a handheld device;
user filling web page form with at least mobile number of the handheld device;
web page form request being sent to said central server as an SMS;
said central server recognizing the request and delivering a WAP push message comprising wireless access point information; and
wireless access point being provisioned on said handheld device

9. A method to facilitate user interaction to provide context sensitive content in a context generation system comprising at least a plurality of handheld devices with Bluetooth service activated, a plurality of Bluetooth terminals providing Bluetooth connectivity, a WLAN terminal and a central server, the method comprising:
a Bluetooth terminal and said central server performing Over-The-Air (OTA) provisioning of wireless access point on a handheld device;
said Bluetooth terminal delivering a web page through Bluetooth to said handheld device, where said handheld device is in the area of coverage of said Bluetooth terminal and where said web page coded in such a way that clicking on links in said page direct request to a local WLAN terminal;
users clicking on said web page to request for content of their interest;
said WLAN terminal decoding and redirecting request to a content source;
said WLAN terminal receiving requested content page from said content source;
said WLAN terminal adding context sensitive information to said received content page; and
said WLAN terminal providing content page to said user.

10. The method as in claim 9, where said content source is a valid source on the Internet.

11. The method as in claim 9, where said context sensitive information is a context sensitive advertisement embedded in said content page sent to a handheld device.

12. The method as in claim 9, where context is built based on at least user requests, user interactions, user location, and user profile information.

13. The method as in claim 9, where OTA provisioning of wireless access point on a handheld device further comprises of:
a Bluetooth terminal sending a web page with form to a handheld device;
user filling web page form with at least mobile number of the handheld device;
web page form request being sent to said central server as an SMS;
said central server recognizing the request and delivering a WAP push message comprising wireless access point information; and
wireless access point being provisioned on said handheld device.

14. A system, said system facilitating user interaction to provide context sensitive content in a context generation system comprising at least a plurality of handheld devices with Bluetooth service activated, a plurality of Bluetooth terminals providing Bluetooth connectivity, a WLAN terminal and a central server, the system performing steps of:
a Bluetooth terminal and said central server performing Over-The-Air (OTA) provisioning of wireless access point on a handheld device;
said Bluetooth terminal delivering a web page through Bluetooth to said handheld device, where said handheld device is in the area of coverage of said Bluetooth terminal and where said web page coded in such a way that clicking on links in said page direct request to a local WLAN terminal;
user clicking on said web page to request for content of their interest;
said WLAN terminal decoding and redirecting request to a content source;
said WLAN terminal receiving requested content page from said content source;
said WLAN terminal adding context sensitive information to said received content page; and
said WLAN terminal providing content page to said user.

15. The system as in claim 14, where OTA provisioning of wireless access point on a handheld device further comprises of said system performing steps of:
a Bluetooth terminal sending a web page with form to a handheld device;
user filling web page form with at least mobile number of the handheld device;
web page form request being sent to said central server as an SMS;
said central server recognizing the request and delivering a WAP push message comprising wireless access point information; and
wireless access point being provisioned on said handheld device.

16. A computer program product, embodied in a computer readable medium comprising program code to execute a method of generating user contexts, to enable context sensitive advertising, by encouraging users of a system to participate through different end points of the system and using information of user actions, profile and location to generate context, the method comprising the steps of:
storing information about users and their profiles at a central server;
registering information of the actions, in which users engage at different end points of the system, and the location of the actions at a central server;
categorizing actions in to pre-defined business events;
generating contexts of users by combining their profile information with the information on business events;
choosing appropriate contexts by filtering the generated contexts based on statistical analysis of previous history of such actions by users.

17. The computer program product as in claim 16, further comprising instructions wherein location of the user is tracked through the end points users engage with.

18. The computer program product as in claim 16, further comprising instructions wherein location of the user is tracked by locating the mobile phone of users while users perform their actions.

19. The computer program product as in claim 16, further comprising instructions wherein the step of generating and filtering a context includes an algorithm for building weighted average table to determine optimal promotion comprising the steps of:
a) collecting business event information;
b) identifying user behavior for a set of same endpoint interactions;
c) identifying user behavior with similar endpoints;
d) identifying summary of interactions of other users with similar profiles for a particular endpoint; and
e) preparing a weighted average of responses of users in different scenarios in a table to identify effectiveness of promotions for a given set of profiles, location, and business events.

20. The computer program product as in claim 16, further comprising instructions wherein initial user profile is generated upon user registration.

21. The computer program product as in claim 16, further comprising instructions wherein the user profile and the user context are updated by tracking user actions to accommodate the most recent behavior in to the context.

22. A method of simplifying user interactions through Bluetooth, the method comprising steps of:
providing at least one central server, for providing Bluetooth connectivity to plurality of handheld devices;
providing at least one Bluetooth terminal, for interfacing between said central server and said plurality of handheld devices;
providing at least one WLAN terminal, for providing content to users of said plurality of handheld devices;
where
said Bluetooth terminal and said central server performing Over-The-Air (OTA) provisioning of wireless access point on a handheld device;
said Bluetooth terminal delivering a web page through Bluetooth to said handheld device, where said handheld device is in the area of coverage of said Bluetooth terminal and where said web page coded in such a way that clicking on links in said page direct request to said WLAN terminal;
users clicking on said web page to request for content of their interest;
said WLAN terminal decoding and redirecting request to a content source;
said WLAN terminal receiving requested content page from said content source;
said WLAN terminal adding context sensitive information to said received content page;
said WLAN terminal encoding received content page such that links are directed to said WLAN terminal; and
said WLAN terminal providing content page to said user.

23. The method as in claim 22, where said content source is a valid URL on the Internet.

24. The method as in claim 22, where said content source is a local content server.

25. The method as in claim 22, where said context sensitive information is a context sensitive advertisement embedded in said content page sent to a handheld device;

26. The method as in claim 22, where context is built based on at least user requests, user interactions, user location, and user profile information.

27. The method as in claim 22, where OTA provisioning of wireless access point on a handheld device further comprises of:
a Bluetooth terminal sending a web page with form to a handheld device;
user filling web page form with at least mobile number of the handheld device;
web page form request being sent to said central server as an SMS;
said central server recognizing the request and delivering a WAP push message comprising wireless access point information; and
wireless access point being provisioned on said handheld device.
